(19) United States
(12) Patent Application Publication
(10) Pub. No.: US 2024/0102456 A1
(43) Pub. Date: Mar. 28, 2024

(54) Earth gravity powered electric generator

(71) Applicant: Bassam Mohammed Balsheh, Spring, TX (US)

(72) Inventor: Bassam Mohammed Balsheh, Spring, TX (US)

(21) Appl. No.: 18/053,042

(22) Filed: Nov. 7, 2022

(30) Foreign Application Priority Data
Sep. 22, 2022 (TR) 2022/014565

(51) Int. Cl. F03G 3/00

(52) U.S. Cl. CPC F03G 3/091; F05B 2250/231; F05B 2250/411; F05B 2270/1014

(57) ABSTRACT

An assembly of a number of reservoirs stacked in a helix shape and filled with certain volume of a fluid is made to rotate continuously by the effect of gravity, where each reservoir has a special geometric shape and design where in the stacked helix of reservoirs the plurality of the torque values due to gravity on one side of the rotation axis is greater than the plurality of the torque values due to gravity on the other side of the rotation axis, resulting in a continuous rotation.

The present invention generally relates to creating a machine that converts Earth gravitational pull into a continuous rotational movement/energy.

### BACKGROUND

Nowadays, environmentally friendly energy production is in high demand. We all know how crucial the production of electricity for mankind. The predominant methods used nowadays are by utilizing relatively expensive fuel (petroleum or coal) which has a significant negative impact on the environment with the excessive production of CO2, or by utilizing nuclear power which poses high risk of accidents and the problem of used radiative nuclear fuel disposal. To solve those issues, mankind tried to utilize other sources or methods to convert the sunlight into electricity or to convert the wind power into electricity. But as we all know, for those solutions to succeed, we must have sunlight, or wind “at a certain speed”. Those two solutions cannot work during cold winters when snowfall is excessive.

This invention solves all those mentioned problems.

This invention does not need fuel, sunlight, or wind. It relies completely on the gravity of the planet, and if we use mercury for example as a fluid, it can work at temperatures as low as −39 degrees Celsius and as high as 200 degrees Celsius.

Energy production using this invention does not require batteries to store electricity because it can be made to run continuously at a constant speed and constant torque power.

This invention, unlike the previous arts, can be industrialized to produce megawatts of electricity per hour per unit.

### SUMMARY

An assembly of a number of reservoirs stacked in a helix shape and filled with certain volume of a fluid is made to rotate continuously by the effect of gravity, where each reservoir has a special geometric shape and design and each has two expandable and retractable compartments where in the stacked helix of reservoirs the plurality of the torque values due to gravity on one side of the rotation axis is greater than the plurality of the torque values due to gravity on the other side of the rotation axis, resulting in a continuous rotation.

This continuous rotational movement can be used to run electric generators.

### BRIEF DESCRIPTION OF THE DRAWINGS

FIG. 1 is a schematic diagram illustrating the stacking of the reservoirs to form a helix shape.

FIG. 2 is a schematic diagram illustrating the stacking of the reservoirs while sharing the same virtual rotational axil.

FIG. 3 is a schematic diagram illustrating the cylinder-shape container with the rotation axil.

FIG. 4 is a schematic diagram illustrating the helix-shaped stack of reservoirs.

FIG. 5 is a schematic diagram illustrating the detailed dimensions of the example geometric shape of the reservoir.

FIG. 6 is a schematic diagram illustrating the co-ordinates of the reservoir's geometric shape rotation center.

FIG. 7 is a schematic diagram illustrating the different parts and compartments of the reservoir.

FIG. 8 is a schematic diagram illustrating the full expansion of compartment C1 and the full retraction of compartment C2 in the reservoir.

### DETAILED DESCRIPTION

This invention generally relates to a machine that allows the conversion of Earth gravitational pull into a continuous rotational mechanical movement/energy, which then can be transformed into other forms of energy like electricity.

This machine, which is the subject matter of this invention, is an assembly of a number of reservoirs stacked in a helix shape and filled with certain volume of a fluid. The machine is made to rotate continuously by the effect of gravity, where each reservoir has a special geometric shape, and each has two expandable and retractable compartments where the plurality of the torque values due to gravity on one side of the rotation axis is greater than the plurality of the torque values due to gravity on the other side of the rotation axis resulting in a continuous rotation.

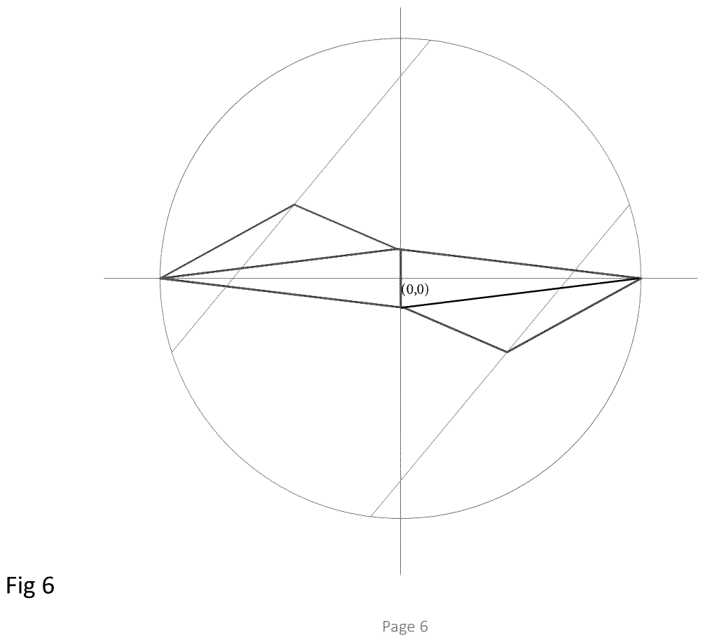

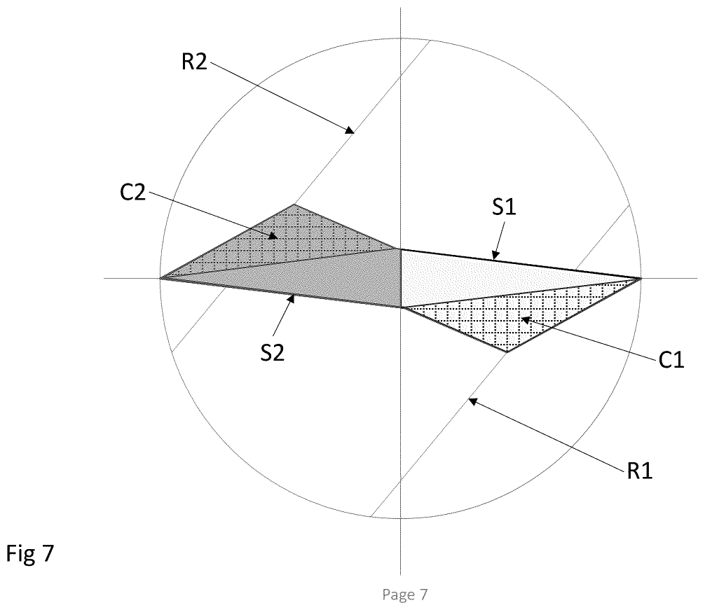

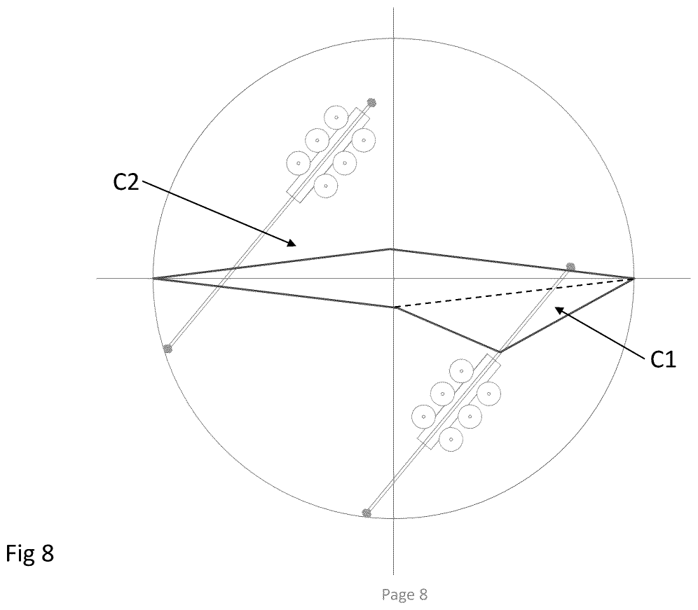

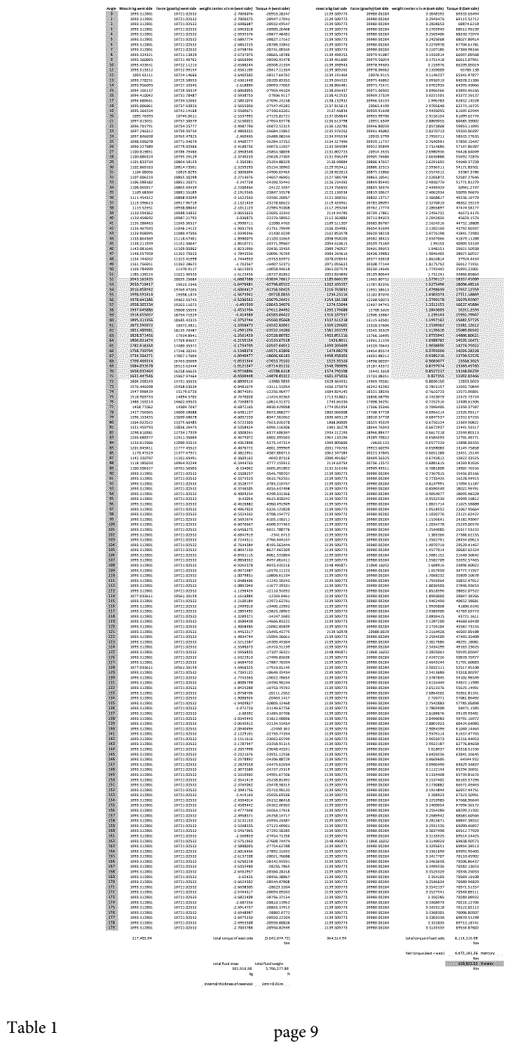

To describe this invention and to explain how it works, we will describe it as follows:
A—The geometric shape of the reservoir:
   The example geometric shape used here has a rotation center with co-ordinates of (0,0) on the XY platform. (FIG. 6)
   One half of the reservoir (Si) is on the west side of the Y axis and the other half is an inverted mirror image of (Si) on the east side of Y axis.
   Rods R1 and R2 are to assist the expansion or retraction of compartments C1 and C2 by the effect of gravity during rotation. (FIG. 7)
   In this example, the reservoirs are filled with mercury at 100% of each reservoir volume during the full expansion of compartment C1 and the full retraction of compartment C2. (FIG. 8)
   Compartments C1 and C2 can be made in other geometric shapes, they can be made of elastic diaphragms or a piston-like structure, or any other shape that guarantee the full expansion and retraction mechanism. The expansion and retraction mechanism can be enhanced by magnets, electric motors, or any other method that guarantee the difference in torque to be always higher on the same side of the direction of rotation.
   In this drawing, the weight center of the west side (point A) is with the co-ordinates of (−2.7006076, 0.097785), while the weight center of the east side (point B) is with the co-ordinates of (3.3048, −5.726429).
   Rod R1 is pulling compartment C1 down, creating more volume of mercury there, while rod R2 is pushing compartment C2 down, pushing the mercury out of C2 compartment. That's in addition to the weight pull of the mass of mercury in C1 and C2.
   The internal thickness of the reservoir is 0.01 meters and the distance between the right tip to the left tip of the reservoir is 16.2 meters.
   The torque power on the west side is 28955.20166 Nm, while the torque power on the east side is 69340.23092 Nm.
   Since the torque power on the east side is higher than the torque power on the west side, then the reservoir will start rotating clockwise.
B—The helix stacking of the reservoirs:
   In this example, 180 identical reservoirs are stacked to form a helix shape and they share the same virtual rotation axel.
   Each reservoir is rotated one degree from the previous reservoir where reservoir 1 is at degree 0, reservoir 2 is at degree 1, reservoir 3 is at degree 2, and so on until reservoir 180 is at degree 179.
   All the reservoirs are attached to each other at this arrangement, and each is filled with mercury at 100% of its volume.
   The east side weight centers, mercury masses, and static torque powers in comparison with the west side weight centers, mercury masses, and static torque powers of all the reservoirs are plotted in table 1. (Table 1)
   From the table (table 1), we see that the cumulative static torque power on the east side of the rotation center is higher than the cumulative static torque power on the west side of the rotation center, which results in the rotation of the helix shape clockwise.
   During the rotation, if we force stop the rotation at any degree of the rotation, the reservoirs will be occupying the same positions, from degree zero to degree 179, regardless of their arrangement. For example, if we look at the reservoirs arrangement after rotating 1 degree, we will find that reservoir 1 is at degree 1, reservoir 2 is at degree 2, and so on until reservoir 180 is at degree 0.
   As the reservoirs rotate together around the rotation axis, each reservoir when it reaches degree 52, compartments C1 and C2 switch status, where C1 retracts while C2 expands with aid of rods R1 and R2, and the helix stack of reservoirs will always maintain the distribution of masses it had at the first reservoirs arrangement.
   This means that the total static torque value at the east side of the rotation center will be always greater than the total static torque value at the west side of the rotation center, which means, the clockwise rotational movement is continuous.
   By measuring the moment of inertia of the rotating cylinder at a certain speed, we can determine the amount of electricity we can generate by using this device.
C—The cylinder-shaped structure:
   In this example, the helix shaped stack of reservoirs is contained in a cylinder-shaped structure to support the weight of the machine. The reservoirs are attached to each other and attached to the inner wall of the cylinder-shaped structure.
   A rotation axel is in the center of each side of the cylinder-shaped structure.
   The two rotation axels are mounted on a structure to lift the cylinder and allow free rotational movement.
   Friction reducing devise can be used on the rotation axels to reduce friction due to rotation.
D—Generating electricity:
   In this example, the cylinder-shaped structure can be wrapped by a belt around its circumference and this belt transfer the rotation energy to the rotation axel of an electric generator.
   The belt can be attached to transmissions to increase or decrease the speed.
   The rotation axel can be attached to a generator via belts, chains, or any other method.
E—Dividing the helix stack of reservoirs:
   The helix stack of reservoirs can be divided into two or more stacks, where each reservoir of the 180 reservoirs is taking one degree position out of the 180 degrees as in the original helix stack, with one reservoir per one degree, and all the stacks are working with each other as one unit through sprockets, gears, or belts, or any other method.
   Since for the machine to operate it doesn't need fuel, wind, or sunlight or any external source of energy other than gravity, it can be isolated from erosion factors like sunlight, rain, humidity, wind, dust, sand, tree pollens dust, industrial dust, and oxidation to prolong the life of its parts.
   This machine can be made small enough to fit in cars, ships, and even aircrafts and submarines, and it can be made big enough to generate electricity in megawatts.

### RELATED ARTS

| | | |
|---|---|---|
| DE202021001660U1 | May 2021 | PETER NIEME |
| IT202000014767A1 | AUGUST 2020 | PRIMO GIOVANNELLI |
| FR3114357A1 | SEPTEMBER 2020 | WILLIAM TIMAU |
| WO2021176287A1 | MARCH 2020 | OZOLINS MAREKS |
| GB2598643A | SEPTEMBER 2020 | BALKEE RAJENDRANATH |
| WO2021171065A1 | FEBREUARY 2020 | CHRISTOPHER MICHAEL FILLORAMO |
| IT202000005131A1 | MARCH 2020 | GIOVANELLI PRIMO |
| DE102019008404A1 | DECEBBER 2019 | ANMELDER GLEICH |
| DE202021003245U1 | DECEMBER 2019 | ANMELDER GLECH |
| DE202021003245U1 | OCTOBER 2021 | PETER NIEME |
| DE10202100244A1 | MAY 2020 | ANMELDER GLEICH |
| WO2022029398A1 | AUGUST 2020 | ROY JEFFERIES |
| WO2021154191A1 | JANUARY 2020 | GOUDARZ GHANIZADEH |
| CN113825664A | MAY 2019 | |
| WO2021182955A1 | MARCH 2020 | SANTANA DE SOUZA |
| WO2022164354A1 | JANUARY 2021 | MUBARAK ALGHAMEDI |
| WO2020168309A1 | FEBRUARY 2020 | THOMAS A. DANIEL |
| US20210199096A1 | JANUARY 2020 | WISAM IBRAHIM |
| DE202022100857U1 | FEBRUARY 2022 | CHIEN-HO CHEN |
| US20220145864A1 | MARCH 2020 | SOEMAR EMID |
| US20220209537A1 | DECEMBER 2021 | ANDREA PEDRETTI |
| ES2742883B2 | AUGUST 2018 | MERIDA ZACARIAS CALVO |
| EP4001644A1 | JULY 2020 | FERNANDEZ A. FRAILE |
| WO2021144616A1 | JANUARY 2020 | AHMADREZA ASHKANPOUR |
| WO2013178973A1 | MAY 2013 | KHALIL ABU AL RUBB |
| EP2784311A1 | MARCH 2014 | RENATO GAI |
| U.S. Pat. No. 3,917,327 | FEBRUARY 1974 | PLASKO EMIL ROBERT |
| U.S. Pat. No. 8,604,634 | JUNE 2009 | JAHIR A. PABON |
| U.S. Pat. No. 6,916,159 | OCTOBER 2005 | BENJAMIN M. RUSH |
| US20140366535 | SEPTEMBER 2014 | STEPHEN HARRISON |
| WO2014145520A2 | MARCH 2014 | JOHN J. COOLEY |
| US20110023977 | AUGUST 2010 | DANIELLE A. FONG |
| US20120255292 | FEBRUARY 2012 | DANIELLE A. FONG |
| U.S. Pat. No. 4,384,459 | OCTOBER 1980 | HAROLD W. JOHNSTON |
| U.S. Pat. No. 7,900,874 | JANUARY 2008 | HARVEY EMANUEL FIALA |
| US20140152016 | DECEMBER 2012 | JAMES EDWARD JENNINGS |
| US20150033724 | AUGUST 2014 | DANIELLE A. FONG |
| US20040112049 | MAY 2003 | PETER EMERY BEHRENS |
| U.S. Pat. No. 5,572,869 | NOVEMBER 1994 | SPENCER C. SCHANTZ |
| U.S. Pat. No. 7,931,178 | DECEMBER 2007 | LAWRENCE C. ROME |
| WO2010143474A | APRIL 2010 | KATSUREN HISASHI |
| WO2016195467A | JUNE 2015 | CASTRO GONZALEZ |
| EP1877662A2 | APRIL 2006 | BENJAMIN M. RUSH |

U.S. APPLICATION 63/374,539 September 2022, BASSAM MOHAMMED BALSHEH Turkish Application Number 2022/014565 September 2022 BASSAM MOHAMMED AMIN BALSHEH

I claim:

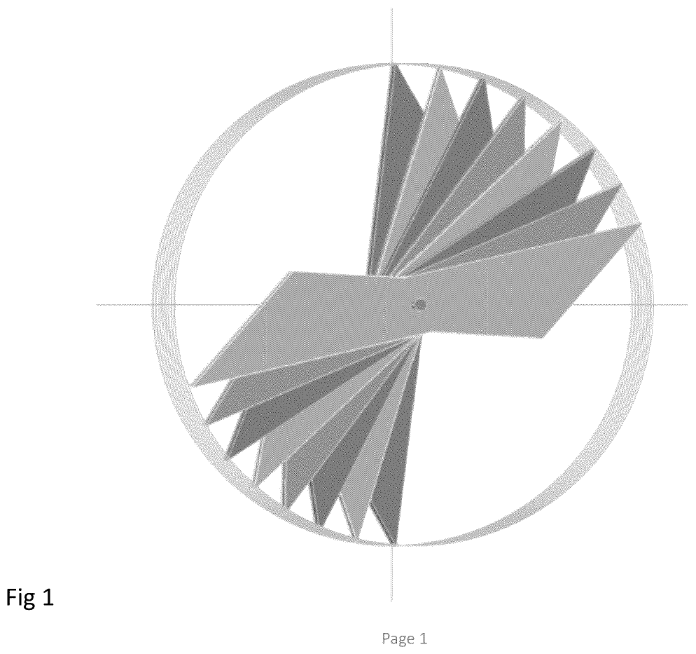

1. An assembly of a number of reservoirs stacked in a helix shape and filled with a certain volume of fluid is made to rotate continuously by the effect of gravity, where each reservoir has a special geometric shape and design, and each has two expandable and retractable compartments where in the stacked helix of reservoirs the plurality of torque values due to gravity on one side of the rotation axis is greater than the plurality of torque values due to gravity on the other side of the rotation axis, resulting in a continuous rotation. (FIG. 1)

2. The assembly of claim 1, wherein the fluid filled in the reservoirs can be mercury, water, antifreeze, or any suitable fluid.

3. The assembly of claim 1, wherein the reservoirs are of identical or different geometric shapes.

4. The assembly of claim 1, where in the geometric shape, and the expandable and retractable compartments of the reservoir, are designed in a way where the torque value due to gravity of one reservoir on one side of the rotation axis at a certain degree is greater than the torque value due to gravity of the reservoir on the other side of the rotation axis at the opposite degree.

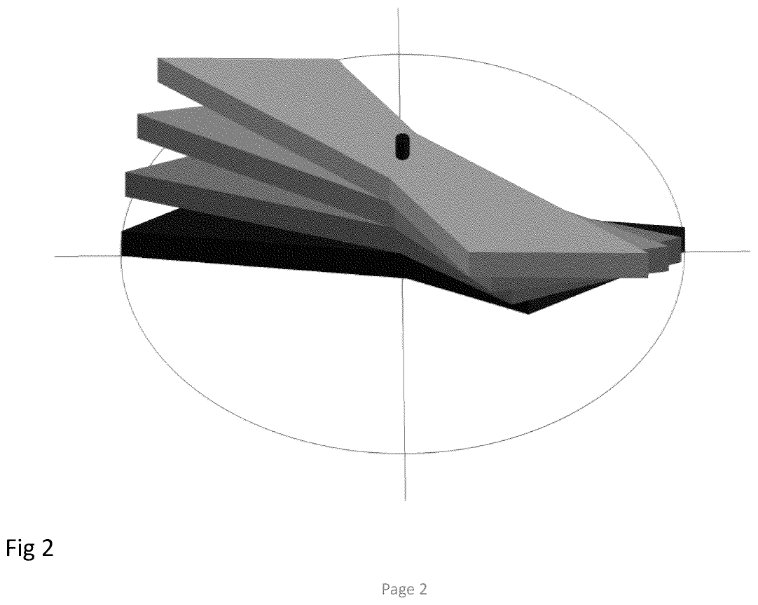

5. The assembly of claim 1, wherein the reservoirs are attached to each other with or without separating distance, and they share the same virtual rotation axis. (FIG. 2)

6. The assembly of claim 4, wherein the expandable and retractable compartments can be made in different geometric shapes, they can be made of elastic diaphragms or a piston-like structure, or any other shape that guarantee the full expansion and retraction mechanism.

7. The assembly of claim 6, wherein the expansion and retraction mechanism can be enhanced by magnets, electric motors, or any other method that guarantee the difference in torque to be always higher on the same side of the direction of rotation.

8. The assembly of claim 6, wherein the two expandable and retractable compartments expand and retract alternatively. When one compartment expands, the other compartment retracts.

9. The assembly of claim 1, wherein the expandable and retractable compartments of the reservoirs expand and retract by the effect of gravity.

10. The assembly of claim 5, wherein the reservoirs can be contained inside and attached to the inner wall of a cylinder shape structure.

11. The assembly of claim 4, wherein the opposite degree to degree 1 is degree 179, and the opposite degree to degree 2 is degree 178, and the opposite degree to degree 3 is degree 177, and so on.

12. The assembly of claim 1, wherein the number of reservoirs can be more than, less than, or equal to 180 reservoirs.

13. The assembly of claim 4, wherein the reservoirs at degree 0 and degree 90 has no opposite reservoirs.

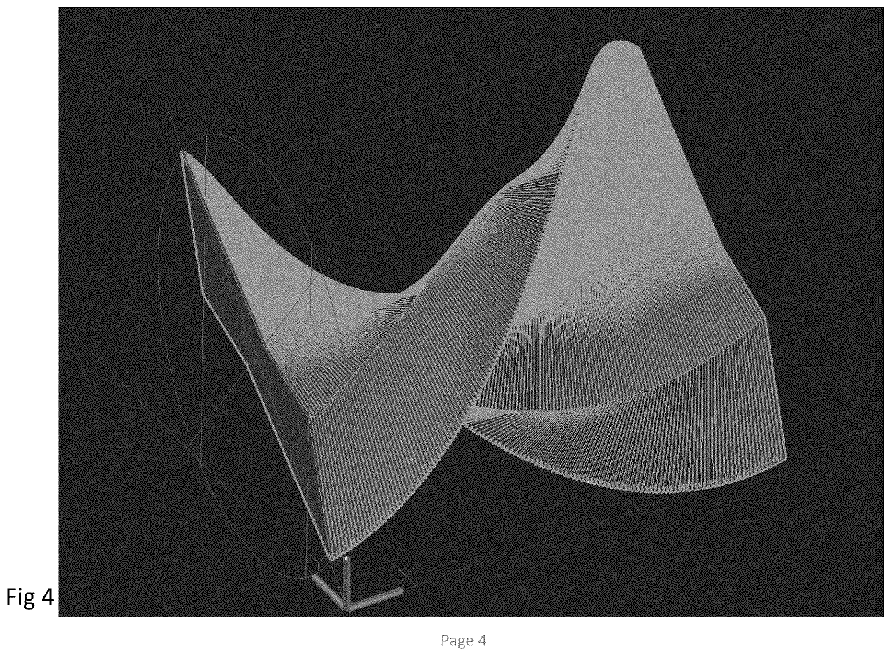

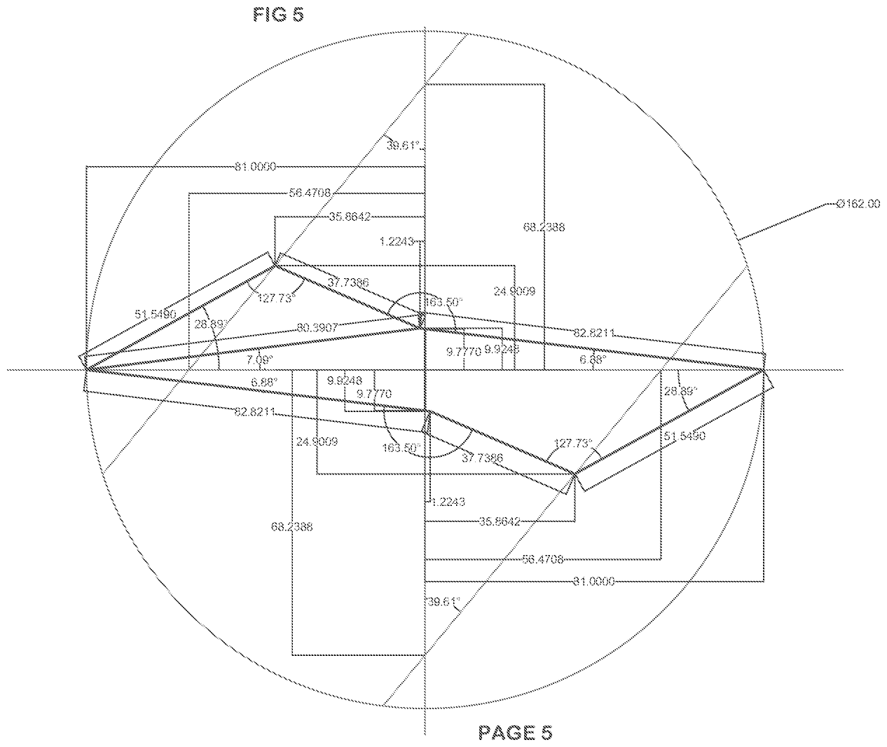

14. The assembly of claim 1, wherein the 180 reservoirs are stacked to form 180 layers in a helix shape where each layer has rotated 1 degree from the previous layer. First layer is at degree 0, second layer is at degree 1, and so on until the last layer at degree 179. (FIG. 4)

15. The assembly of claim 13, wherein each layer can be rotated more than or less than one degree.

16. The continuous rotation produced by this invention can be utilized to generate electricity by mounting magnets on it, and metal coils around it, or by transferring the continuous motion to a generator to generate electricity, or any other method that results in generating electricity.

17. The torque power and rotation speed generated by this invention can be increased or decreased by utilizing transmissions, brakes, flywheels, and by changing the size, shape, and number of reservoirs.

18. This invention can be made at any size where the support of its weight is possible.

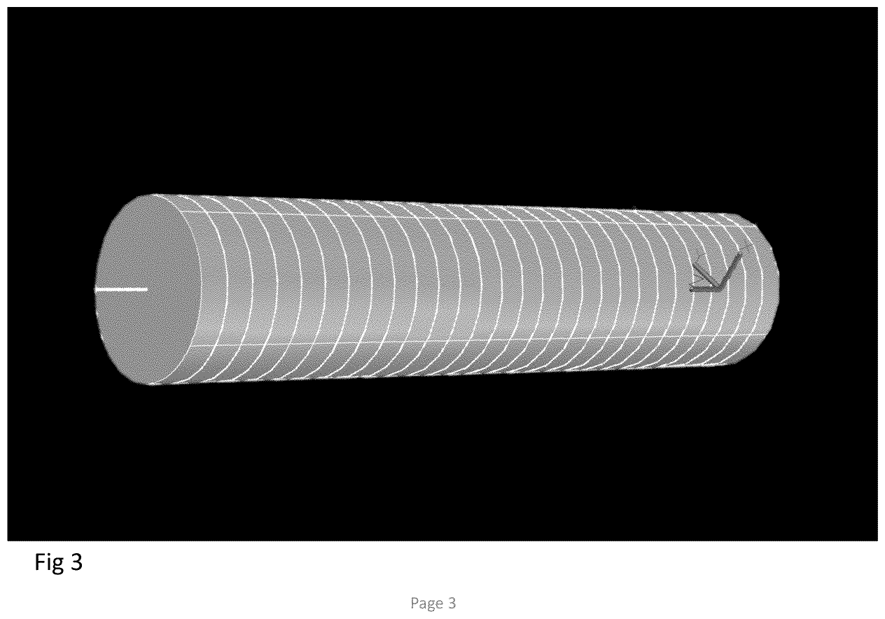

19. The assembly of claim 6, wherein the cylinder shape structure has one rotation axel in the center of each of its two sides. (FIG. 3)

20. The assembly of claim 19, wherein the rotation axels are attached to friction reducing devices like bearing wheels.

21. The assembly of claim 19, wherein the two axels are attached to structures to keep the cylinder shape structure elevated to allow free rotational movement.

22. One example of a geometric shape of the reservoir is explained in FIG. 5. (FIG. 5)

23. The assembly of claim 6, wherein the cylinder shape structure can be designed to tolerate its weight and the weight of the filled reservoirs.

24. The rotation speed of this invention can be controlled in a way to minimize the effect of the centrifugal force on the fluid contained in the reservoirs to maintain a constant rotational speed.

25. The stack of reservoirs can be divided into several stacks while keeping the arrangement of the reservoirs in respect to their one-degree difference always there.
